(19) United States
(12) Patent Application Publication
(10) Pub. No.: US 2011/0096000 A1
(43) Pub. Date: Apr. 28, 2011

(54) TOUCH STRUCTURE AND TOUCH DISPLAY APPARATUS COMPRISING THE SAME

(75) Inventors: Tien-haw Peng, Hsinchu (TW); Kai-Cheng Chuang, Hsinchu (TW); Gwo-Feng Hwang, Hsinchu (TW)

(73) Assignee: PRIME VIEW INTERNATIONAL CO., LTD., Hsinchu (TW)

(21) Appl. No.: 12/762,851

(22) Filed: Apr. 19, 2010

(30) Foreign Application Priority Data
Oct. 23, 2009 (TW) 098135916

(51) Int. Cl. G06F 3/041

(52) U.S. Cl. 345/173

(57) ABSTRACT

A touch structure and a touch display apparatus comprising the same are provided. The touch display apparatus has a touch controller electrically connected to the touch structure. The touch structure comprises a display panel with a display surface and a sense assembly. The sense assembly is disposed on a surface opposite to the display surface and electrically connected to the touch controller to generate a touch signal while the display surface of the display panel is touched so that the touch controller may act according to the touch signal.

This application claims priority to Taiwan Patent Application No. 098135916 filed on Oct. 23, 2009.

### CROSS-REFERENCES TO RELATED APPLICATIONS

Not applicable.

### BACKGROUND OF THE INVENTION

1. Field of the Invention

The present invention relates to a touch structure and a touch display apparatus comprising the same. Specifically, the present invention relates to a touch structure, disposed on a surface opposite to a display surface of a display panel, and a touch display apparatus comprising the same.

2. Descriptions of the Related Art

Input devices are important and indispensable peripheral devices for computers because these devices provide the only means of operating a computer. Computer input devices commonly found in the market include keyboards, mice, presenters and tablets. The user may decide what type of input device to use depending on her or his needs. However, most of input devices require the user to learn the specific operating procedure of such devices, for example, that of a mouse, a tablet or a relatively complex input method of a keyboard. None of these operation manners is intuitive for the user.

To allow the user to operate a computer system more intuitively, associated touch input devices have been developed, among which, touch screens that incorporate both a touch input device and a display apparatus have become very popular. When using a touch screen, the computer system may present its operation interface through the display apparatus thereof, in combination with the touch input device, and allow the user to perform associated operations directly onto the display apparatus intuitively. Currently, touch screens are commonly applied in many devices, such as cell phones, mobile assistants, satellite navigation units, electronic books and the like.

However, with the touch screens currently available, the touch input devices are all disposed on a display surface of the display apparatus to function properly. In other words, for the user to see what is seen on the display apparatus, the touch input device must be made with both transparent and touch characteristics. Therefore, expensive glass or indium tin oxide (ITO) materials are generally used as substrates of the touch input devices. Aside from the drawback arising from using expensive materials, disposing the touch input device on the display surface of the display apparatus also degrades the visual luminance of the display apparatus, leading to visual fatigue in the user.

Accordingly, efforts still have to be made in the art to simultaneously reduce the production cost and enhance the visual luminance of the touch screens.

### SUMMARY OF THE INVENTION

To solve the aforesaid problem, an objective of the present invention is to provide a touch structure for use in a touch display apparatus, which may simultaneously reduce the cost and obviate degradation in the luminance of the touch display apparatus.

The present invention provides a touch structure for use in a touch display apparatus. The touch display apparatus has a touch controller electrically connected to the touch structure. The touch structure comprises a display panel and a sense assembly wherein the display panel has a display surface, the sense assembly is disposed on a surface opposite to the display surface and electrically connected to the touch controller to generate a touch signal when the display surface of the display panel is touched so that the touch controller may act according to the touch signal The sense assembly comprises a first sense layer, a second sense layer and an isolation layer wherein the first sense layer has a first conductor, the second sense layer has a second conductor and the isolation layer is disposed between the first sense layer and the second sense layer to electrically isolate the first conductor from the second conductor. The isolation layer may define a space between the first sense layer and the second sense layer, a conduction state may occur between the first conductor and the second conductor through the space to generate the touch signal when the display surface of the touch panel is touched.

Another objective of the present invention is to provide a touch display apparatus, which comprises a touch controller and a touch structure as described above. The touch controller is electrically connected to the touch structure so that the touch controller may act according to a touch signal transmitted from the touch structure.

According to the above description, the arrangement of the present invention obviates the need of disposing the touch structure on the display surface, so the touch structure will no longer require the use of expensive transparent materials as a substrate. In addition, degradation in the luminance due to the sheltering of the display surface of the display panel by the sense assembly is also prevented. Thereby, the present invention effectively overcomes the problem of the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a touch display apparatus of the present invention;

FIG. 2 is a schematic view of a touch structure of the present invention; and

FIG. 3 is a schematic exploded view of a sense assembly of the present invention.

### DESCRIPTION OF THE PREFERRED EMBODIMENT

In the following description, a touch structure of the present invention will be explained with reference to embodiments thereof. However, it should be appreciated that these embodiments are not intended to limit the present invention to any specific environment, applications or particular implementations described in these embodiments. Therefore, the description of these embodiments is only for purposes of illustration rather than limitation.

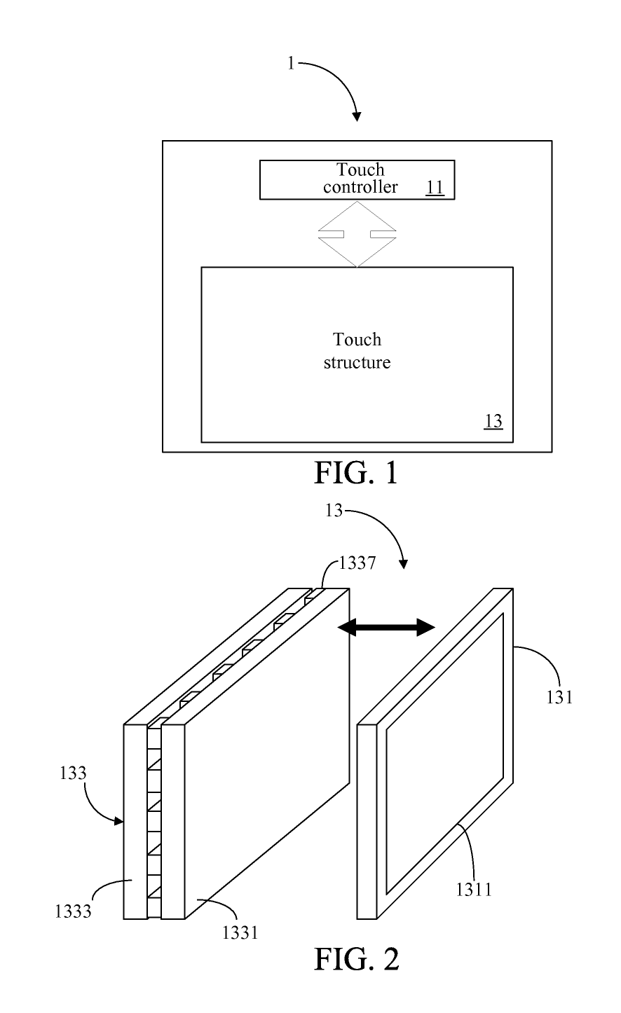

FIG. 1 illustrates a schematic view of a touch display apparatus 1 of the present invention. The touch display apparatus 1 comprises a touch controller 11 and a touch structure 13. The touch controller 11 is electrically connected to the touch structure 13 and configured to act according to a touch signal (not shown) transmitted from the touch structure 13. The principal in which the touch signal is generated will be detailed later.

FIG. 2 illustrates a schematic view of the touch structure 13. The touch structure 13 comprises a display panel 131 and a sense assembly 133. The display panel 131 has a display surface 1311, while the sense assembly 133 is disposed on a surface opposite to the display surface. With this arrangement, a frame presented on the display surface 1311 may be directly presented to the user without suffering from luminance degradation due to sheltering by the sense assembly 133. The sense assembly 133 is configured to generate the touch signal when the display surface 1311 of the display panel 131 is touched by the user. Next, to fully disclose the present invention, construction of the sense assembly 133 as well as how the touch signal is generated and transmitted to the touch controller 11 will be further explained.

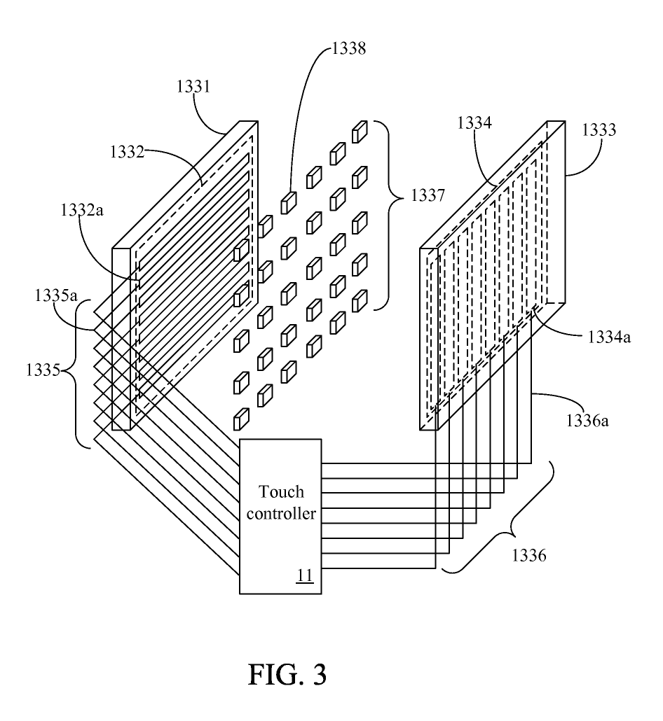

In reference to both FIGS. 2 and 3, FIG. 3 is a schematic exploded view of the sense assembly 133. As can be seen from FIG. 3, the sense assembly 133 comprises a first sense layer 1331 with a plurality of first conductors 1332, a second sense layer 1333 with a plurality of second conductors 1334, a plurality of first conducting wires 1335 disposed corresponding to the first conductors 1332, a plurality of second conducting wires 1336 disposed corresponding to the second conductors 1334, and an isolation layer 1337. It shall be particularly emphasized that the first sense layer 1331 and the second sense layer 1333 may be made of flexible polyvinyl chloride, polyethylene terephthalate, polyimide, polyetheretherketone, polyethylene naphthalene-2,6-dicarboxylate, or a combination thereof. The first conductors 1332 and the second conductors 1334 may be made of a conductive material such as gold, copper, carbon, silver, tin, or conductive polymer; however, the materials described above are only provided as an example of this embodiment but not to limit the present invention.

The isolation layer 1337 is disposed between the first sense layer 1331 and the second sense layer 1333 to electrically isolate the first conductors 1332 from the second conductors 1334. In more detail, the isolation layer 1337 comprises a plurality of blocks 1338 for defining a plurality of spaces between the first sense layer 1331 and the second sense layer 1333. The first conductors 1332 and the second conductors 1334 are separated by these spaces for electrical isolation purposes. In this embodiment, the blocks 1338 may be made of a nonconductive material such as polyvinyl chloride or photoresist; however, in other embodiments, the blocks 1338 may be made of other insulation materials rather than being limited thereto.

Additionally, the first conductors 1332 and the second conductors 1334 are electrically connected to the touch controller 11 through the first conducting wires 1335 and the second conducting wires 1336 respectively. In this embodiment, the touch controller 11 may supply a scan voltage (not shown) to each of the first conductors 1332 in sequence through the first conducting wires 1335. When the display surface 1311 of the display panel 131 is touched by the user, the first sense layer 1331 will be deformed/depressed towards the second sense layer 1333 according to the touch, causing the first conductors 1332, through the spaces defined by the blocks 1338 between the first sense layer 1331 and the second sense layer 1333, to make contact with the second conductor 1334 to result in a conducting status. At this point, the scan voltage is transferred from the first conductors 1332 to the second conductors 1334 to generate the touch signal, which is then transmitted through the second conducting wires 1336 back to the touch controller 11 so that the touch position can be determined by the touch controller 11.

Specifically, the first conductors 1332 of this embodiment are disposed horizontally and independently on the first sense layer 1331. The second conductors 1334 are all disposed perpendicularly and independently on the second sense layer 1332, so when the display surface 1311 is viewed from above, a lot of intersections shaped like lattice points will be substantially defined by the first conductors 1332 and the second conductors 1334 together. Hence, by using coordinates of the intersections, the touch controller 11 may readily determine where the electrical conduction occurs and thus, where the touch occurs.

For example, when the touch controller 11 supplies the scan voltage to the first conductor 1332a through the first conducting wire 1335a, a touch on the display panel 1311 of the display panel 131 by the user will cause the first conductor 1332a to make contact with the second conductor 1334a to result in a conducting status. Then, the scan voltage is translated by the second conductor 1334a into the touch signal, which is then transmitted through the second conducting wire 1336a back to the touch controller 11. In this way, the touch controller 11 may detect a pressing at a location where the first conductor 1332a overlaps the second conductor 1334a, thereby, determining the position of the pressing action. With the principle describe above, a higher pressing force will result in a larger overlapping area between the first conductors 1332 and the second conductors 1334, so the magnitude of the pressing force may also be determined accordingly. Furthermore, a multi-touch detection may also be accomplished.

According to the above description, the arrangement of the present invention obviates the need of disposing the touch structure on the display surface, so the touch structure will no longer require the use of expensive transparent materials as a substrate. In addition, luminance degradation due to sheltering of the display surface of the display panel by the sense assembly is prevented. Thereby, the present invention effectively overcomes the problem of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A touch structure for use in a touch display apparatus, the touch display apparatus having a touch controller electrically connected to the touch structure, the touch structure comprising:
a display panel, having a display surface; and
a sense assembly, being disposed on a surface opposite to the display surface and electrically connected to the touch controller to generate a touch signal while the display surface of the display panel is touched so that the touch controller may act according to the touch signal, the sense assembly comprising:
a first sense layer, having a first conductor;
a second sense layer, having a second conductor; and
an isolation layer, being disposed between the first sense layer and the second sense layer to electrically isolate the first conductor from the second conductor;
wherein the isolation layer may define a space between the first sense layer and the second sense layer, a conduction state may occur between the first conductor and the second conductor through the space to generate the touch signal when the display surface of the touch panel is touched.

2. The touch structure as claimed in claim 1, further comprising a first conducting wire corresponding to the first conductor; the first conductor being electrically connected to the touch controller through the first conducting wire to receive a scan voltage supplied from the touch controller.

3. The touch structure as claimed in claim 2, further comprising a second conducting wire corresponding to the second conductor; the second conductor being electrically connected to the touch controller through the second conducting wire so that the second conductor may translate the scan voltage into the touch signal when the conducting state occurs between the first conductor and the second conductor, the touch signal being transmitted to the touch controller through the second conducting wire.

4. The touch structure as claimed in claim 1, wherein a material of the first sense layer and the second sense layer comprises polyvinyl chloride, polyethylene terephthalate, polyimide, polyetheretherketone, polyethylene naphthalene-2,6-dicarboxylate, and a combination thereof.

5. The touch structure as claimed in claim 1, wherein a material of the first conductor and the second conductor comprises gold, copper, carbon, silver, tin, conductive polymer, and a combination thereof.

6. The touch structure as claimed in claim 1, wherein the isolation layer comprises a plurality of blocks for defining the space.

7. The touch structure as claimed in claim 6, wherein a material of the blocks comprises one of polyvinyl chloride and photoresist.

8. A touch display apparatus, comprising:
a touch controller; and
a touch structure, comprising:
a display panel, having a display surface; and
a sense assembly, being disposed on a surface opposite to the display surface and electrically connected to the touch controller to generate a touch signal while the display surface of the display panel is touched so that the touch controller may act according to the touch signal, the sense assembly comprising:
a first sense layer, having a first conductor;
a second sense layer, having a second conductor; and
an isolation layer, being disposed between the first sense layer and the second sense layer to electrically isolate the first conductor from the second conductor;
wherein the isolation layer may define a space between the first sense layer and the second sense layer, a conducting state may occur between the first conductor and the second conductor through the space to generate the touch signal when the display surface of the touch panel is touched.

9. The touch display apparatus as claimed in claim 8, further comprising a first conducting wire corresponding to the first conductor, the first conductor being electrically connected to the touch controller through the first conducting wire to receive a scan voltage supplied from the touch controller.

10. The touch display apparatus as claimed in claim 9, further comprising a second conducting wire corresponding to the second conductor, the second conductor being electrically connected to the touch controller through the second conducting wire so that the second conductor may translate the scan voltage into the touch signal when the conducting state occurs between the first conductor and the second conductor, the touch signal being transmitted to the touch controller through the second conducting wire.

11. The touch display apparatus as claimed in claim 8, wherein a material of the first sense layer and the second sense layer comprises polyvinyl chloride, polyethylene terephthalate, polyimide, polyetheretherketone, polyethylene naphthalene-2,6-dicarboxylate, and a combination thereof.

12. The touch display apparatus as claimed in claim 8, wherein a material of the first conductor and the second conductor comprises gold, copper, carbon, silver, tin, conductive polymer and a combination thereof.

13. The touch display apparatus as claimed in claim 8, wherein the isolation layer comprises a plurality of blocks for defining the space.

14. The touch display apparatus as claimed in claim 13, wherein a material of the blocks comprises one of polyvinyl chloride and photoresist.
